(19) United States
(12) Patent Application Publication
(10) Pub. No.: US 2011/0097681 A1
(43) Pub. Date: Apr. 28, 2011

(54) Substrate Processing Equipment

(76) Inventor: Euy Kyu LEE, Yongin-si (KR)

(21) Appl. No.: 12/911,381

(22) Filed: Dec. 21, 2010

(30) Foreign Application Priority Data
Oct. 23, 2009 (KR) 10-2009-0101043
Oct. 6, 2010 (KR) 10-2010-0097194

(51) Int. Cl. F27D 1/00

(52) U.S. Cl. 432/120; 29/428

(57) ABSTRACT

Provided is a substrate processing equipment having a blocking part capable of partially blocking heat transfer to the central region of a reaction space of a chamber to uniformly heat the reaction space. The equipment includes: a chamber; a substrate holding part disposed in the reaction space to hold and rotate a substrate; a first heating part disposed at a lower central region of the chamber to heat the central region of the reaction space; a second heating part disposed at a lower peripheral region of the chamber to heat a peripheral region of the reaction space; and a blocking part. The blocking part is disposed between the first and second heating parts, and a top portion thereof is extended toward the above of the second heating part to block transfer of heat generated by the second heating part to the central region of the reaction space.

### CROSS-REFERENCE TO RELATED APPLICATION

This application claims priority to Korean Patent Application Nos. 10-2009-0101043 filed on Oct. 23, 2009 and 10-2010-0097194 filed on Oct. 6, 2010, and all the benefits accruing therefrom under 35 U.S.C. §119, the contents of which are incorporated by reference in their entirety.

### BACKGROUND

The present disclosure relates to a substrate processing equipment, and more particularly, to a substrate processing equipment having a blocking part capable of partially blocking heat transfer to the central region of a reaction space of a chamber to uniformly heat the reaction space.

Substrate processing equipments are generally used for depositing a layer on a semiconductor substrate or etching a layer deposited on a semiconductor substrate. Therefore, layers are formed and etched with substrate processing equipments, so that semiconductor devices, flat display panels, optical devices, solar cells, etc. can be manufactured.

To deposit a thin film on a substrate with a substrate processing equipment, the substrate is seated on a substrate holding part within the substrate processing equipment, and then a predetermined film is formed on the surface of the substrate through a chemical or physical deposition process. Typically, a processing gas is discharged into a reaction space of the substrate processing equipment during formation of a predetermined layer on a substrate surface.

Due to recent increases in substrate size, however, depositing thin films with uniform thicknesses on a substrate surface requires more advanced technologies than ever. Achieving uniform distribution of a processing gas across a substrate surface is usually not easy, and therefore considered as one of the primary difficulties in manufacturing large substrates. In the related art, thickness uniformity of a thin film deposited on a semiconductor substrate is improved by rotating the substrate.

The peripheral region of the chamber experiences more heat loss than the central region of the chamber due to its configuration. Keeping temperatures at the peripheral region and the central region of the chamber uniform, therefore, is also not easy and causes another difficulty. To compensate the uneven temperature distribution and improve heating uniformity within the chamber, in the related art heating parts are arranged in a lower portion of the chamber such that a heater at the center region is disposed relatively lower than a heater at the periphery region.

However, the above arrangement of the heaters is not able to fully overcome the difficulties caused by uneven temperature distribution and non-uniform heat loss of the central region and the peripheral region inside the chamber.

### SUMMARY

The present disclosure provides a substrate processing equipment capable of partially blocking heat transfer to the central region of a reaction space of a chamber by means of a blocking part provided between a heating part disposed at a lower central region of the chamber and a heating part disposed at a lower peripheral region of the chamber.

The present disclosure also provides a substrate processing equipment including blocking parts of which lengths and inclined angles are different depending on their locations.

The present disclosure further provides a substrate processing equipment including blocking parts of which lengths and inclined angles are variable.

In accordance with an exemplary embodiment, a substrate processing equipment includes: a chamber including a reaction space; a substrate holding part in the reaction space and adapted to hold and rotate a substrate; a first heating part below a central region of the chamber and adapted to heat a central region of the reaction space; at least one second heating part below a peripheral region of the chamber and adapted to heat a peripheral region of the reaction space; a blocking part between the first heating part and the second heating part, the blocking part having a top portion above the second heating part, and configured to block transfer of heat from the second heating part to the central region of the reaction space.

The blocking part may include: a vertical blocking plate between the first heating part and the second heating part; and an inclined blocking plate at an uppermost end of the vertical blocking plate, extending and inclined upwardly above the second heating part.

The blocking part may include a curved blocking plate between the first heating part and the second heating part, with an upper portion thereof extending above the second heating part.

The second heating part may be provided in plurality and spaced apart from each other, the substrate processing equipment may further include a supporting portion below the chamber, the supporting portion supporting the first heating part and the second heating part, and the supporting portion may include a plurality of partitioning plates for partitioning at least the second heating parts.

The blocking part may include: a plurality of vertical blocking plates between the first heating part and the second heating parts, separated by the plurality of partitioning plates; and an inclined blocking plate at an uppermost end of the respective vertical blocking plates, extending and inclined upwardly above the second heating part.

At least one of the plurality of vertical blocking plates has a different height from another of the plurality of vertical blocking plates.

At least one inclined blocking plate extends at a different angle with respect to the vertical blocking plate from another inclined blocking plate.

At least one inclined blocking plate has a different length from another inclined blocking plate.

The inclined blocking plate may be pivotable at the uppermost end of the vertical blocking plate.

The inclined blocking plate may be fixed to a hinge at the uppermost end of the vertical blocking plate.

The inclined blocking plate may have a variable length.

Each inclined blocking plate may include: a slidermain body at the uppermost end of the respective vertical blocking plate, extending and inclined upwardly above the second heating part, and comprising a groove or opening at an end thereof; and a sub body configured to extend from and retract into the slider groove or opening, above the second heating part.

Each inclined blocking plate may include: a main body at the uppermost end of the vertical blocking plate, extending and inclined upwardly above the second heating part; and an extending sub body comprising a groove or opening at an end thereof, the extending sub body configured to slide along at least one surface of the main body, above the second heating part.

The blocking part may include a plurality of curved blocking plates between the first heating part and the second heating part, the curved blocking plates being separated by the plurality of partitioning plates, and an upper portion of the curved blocking plates extends above of second heating part.

At least one of the plurality of curved blocking plates may have a different length from another of the plurality of the curved blocking plates.

At least one of the plurality of curved blocking plates has a different radius of curvature than another of the plurality of the curved blocking plates.

Each of the plurality of curved blocking plates may have a lower portion between the first heating part and the second heating part, and an upper portion extending above the second heating part, and the upper portion is pivotable with respect to the lower portion and has a variable inclined angle.

Each of the plurality of curved blocking plates may include a hinge between the lower portion and the upper portion.

Each of the plurality of curved blocking plates may have a lower portion between the first heating part and the second heating part, and an upper portion extending above the second heating part, and the upper portion extends away from the lower portion, or retracts towards the lower portion, to enable each curved blocking plate to have a variable length.

The substrate processing equipment may further include a supporting portion below the chamber, supporting the first heating part and the second heating part, wherein the supporting portion has a stepped configuration such that the second heating part is above the first heating part.

A method of making substrate processing equipment may include: assembling a chamber comprising a reaction space, a substrate holding part in the reaction space and adapted to hold and rotate a substrate, a first heating part below a central region of the chamber and adapted to heat a central region of the reaction space, and a second heating part below a peripheral region of the chamber and adapted to heat a peripheral region of the reaction space; and attaching a blocking part between the first heating part and the second heating part, the blocking part having a top portion above the second heating part, and configured to block transfer of heat from the second heating part to the central region of the reaction space.

A method of affecting heat transfer in substrate processing equipment may include: attaching a blocking part between first and second heating parts in the substrate processing equipment, the substrate processing equipment comprising a chamber comprising a reaction space, a substrate holding part in the reaction space and adapted to hold and rotate a substrate, the first heating part, below a central region of the chamber and adapted to heat a central region of the reaction space, and the second heating part, below a peripheral region of the chamber and adapted to heat a peripheral region of the reaction space, the blocking part having a top portion above the second heating part, configured to block transfer of heat from the second heating part to the central region of the reaction space; and optionally, extending an upper portion of the blocking part above of the second heating part or retracting the upper portion of the blocking part top portion towards a lower portion of the blocking part top portion, to change a transfer of heat from the second heating part to the central region of the reaction space.

### BRIEF DESCRIPTION OF THE DRAWINGS

Exemplary embodiments can be understood in more detail from the following description taken in conjunction with the accompanying drawings, in which:

FIG. 1 is a schematic sectional view of a substrate processing equipment in accordance with an exemplary embodiment;

FIG. 2 is a vertical schematic sectional view of a heating part and a blocking part in accordance with an exemplary embodiment;

FIG. 3 is a horizontal schematic sectional view of a heating part and a blocking part in accordance with a modification of an exemplary embodiment;

FIG. 4 illustrates vertical schematic sections of main portions of FIG. 3;

FIG. 5 is a horizontal schematic sectional view of a heating part and a blocking part in accordance with another modification of an exemplary embodiment;

FIG. 6 illustrates horizontal schematic sectional views of a heating part and a blocking part in accordance with still another modification of an exemplary embodiment;

FIGS. 7 to 9 are vertical schematic sectional views of a heating part and a blocking part in accordance with other exemplary embodiments;

FIG. 10 is a schematic sectional view of a substrate processing equipment in accordance with another exemplary embodiment; and

FIGS. 11 to 15 are vertical schematic sectional views of a heating part and a blocking part in accordance with a modification of another exemplary embodiment.

### DETAILED DESCRIPTION OF EMBODIMENTS

Hereinafter, specific embodiments will be described in detail with reference to the accompanying drawings. In the drawings, like reference numerals refer to like elements.

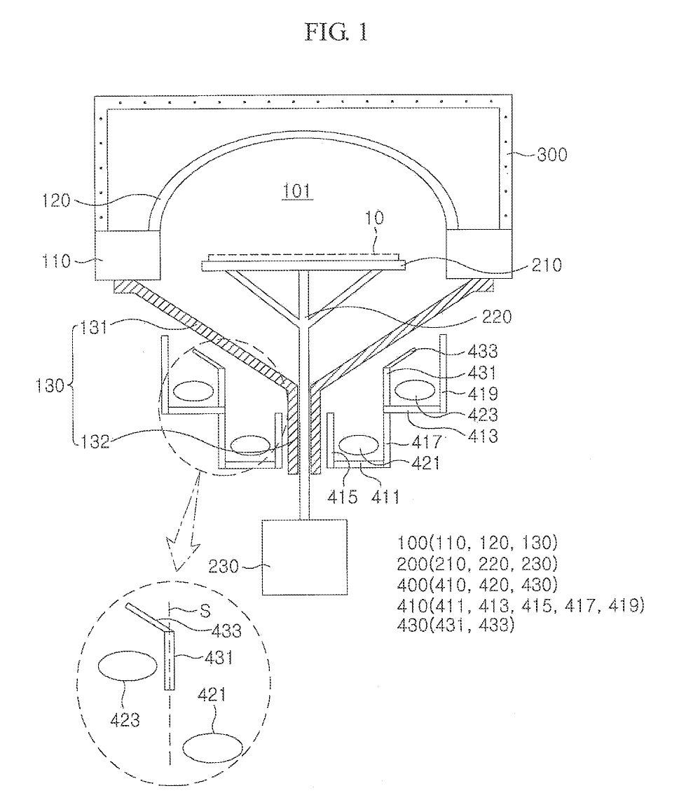

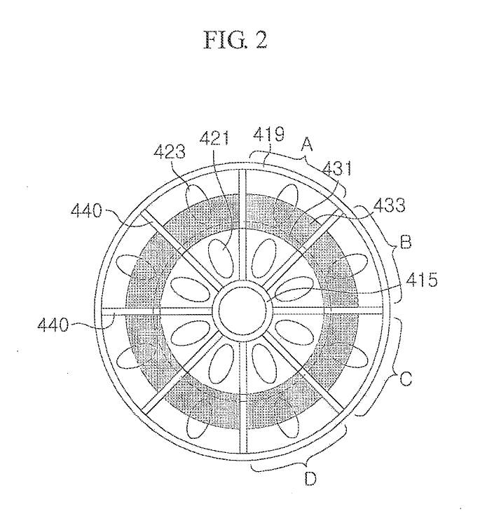

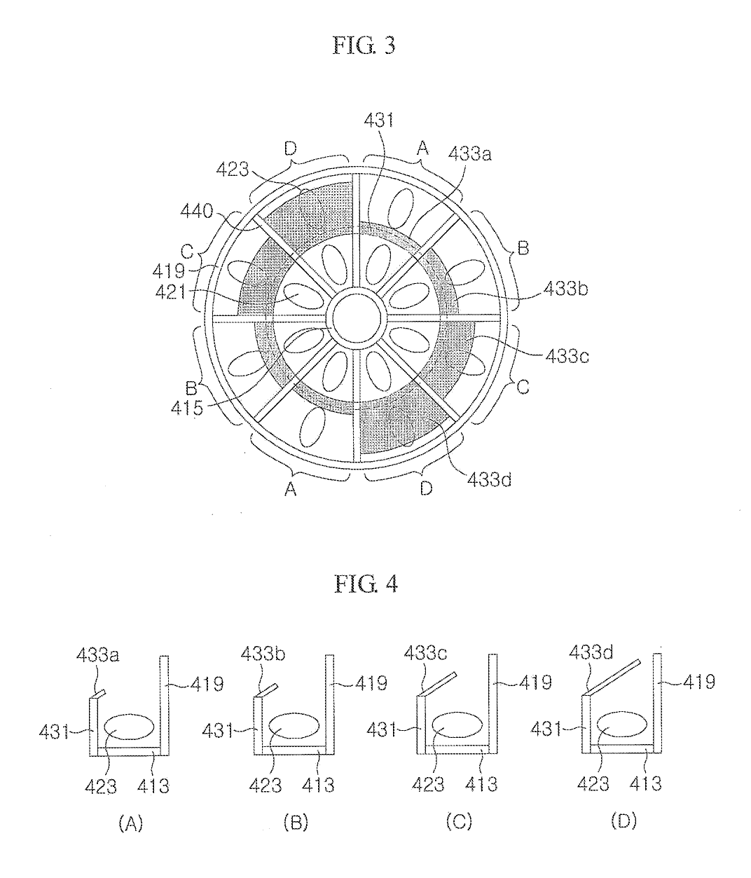

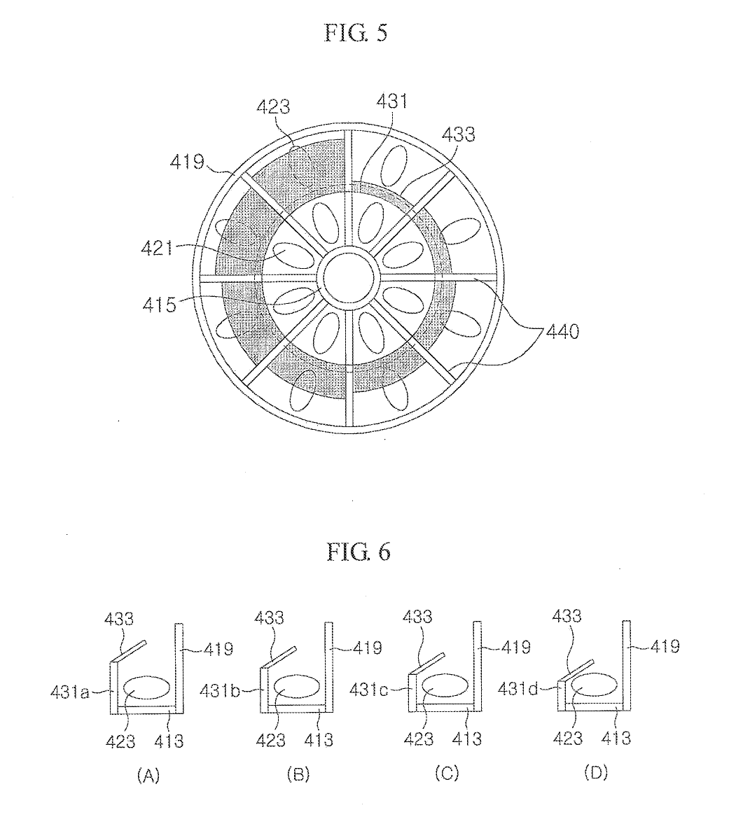

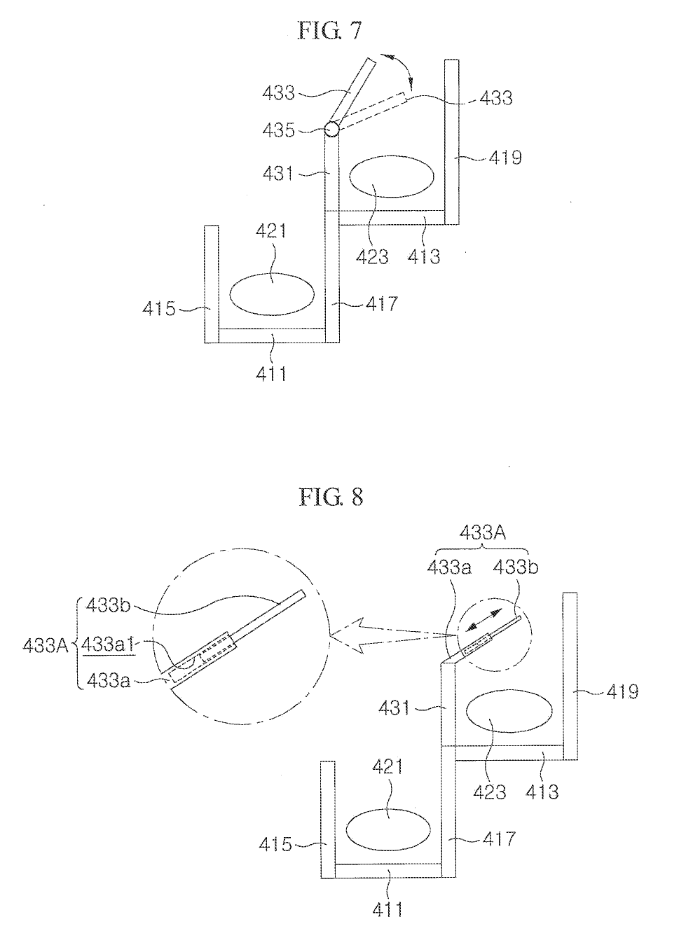

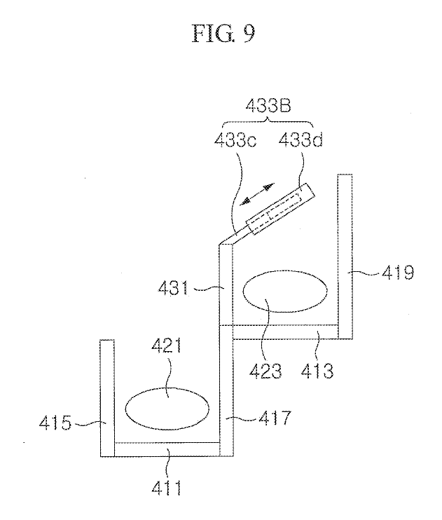

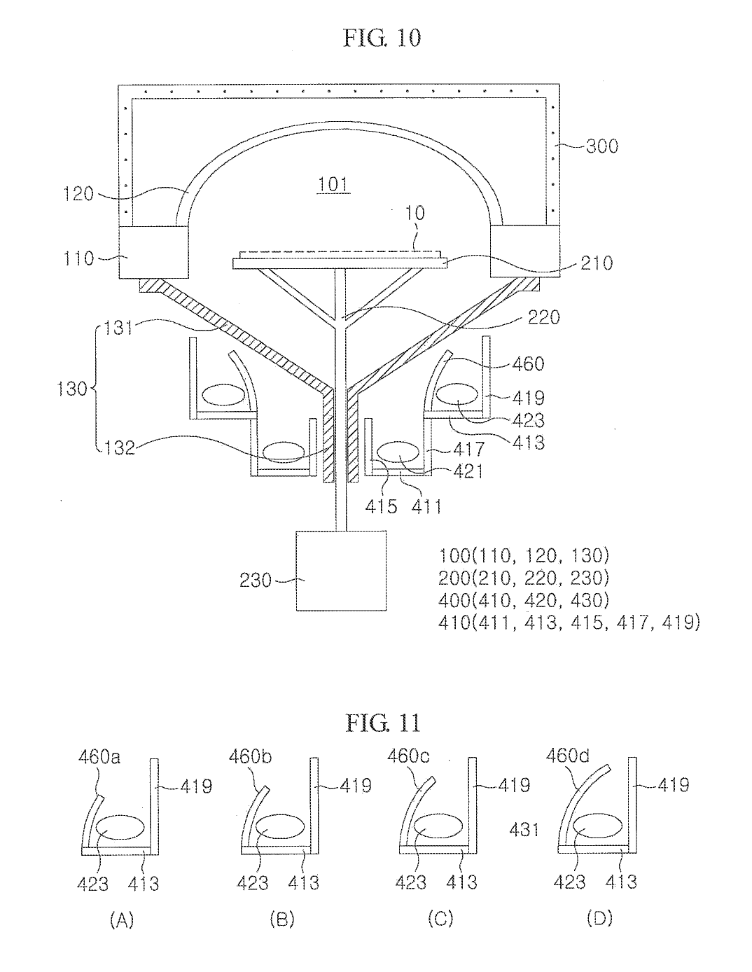

FIG. 1 is a schematic sectional view of a substrate processing equipment in accordance with an exemplary embodiment, FIG. 2 is a vertical schematic sectional view of a heating part and a blocking part in accordance with an exemplary embodiment, FIG. 3 is a horizontal schematic sectional view of a heating part and a blocking part in accordance with a modification of an exemplary embodiment, FIG. 4 illustrates vertical schematic sections of main portions of FIG. 3, FIG. 5 is a horizontal schematic sectional view of a heating part and a blocking part in accordance with another modification of an exemplary embodiment, FIG. 6 illustrates horizontal schematic sectional views of a heating part and a blocking part in accordance with still another modification of an exemplary embodiment, and FIGS. 7 to 9 are vertical schematic sectional views of a heating part and a blocking part in accordance with other exemplary embodiments.

Referring to FIGS. 1 to 9, a substrate processing equipment according to the exemplary embodiments includes: a chamber 100 having a reaction space 101; a substrate holding part 200 disposed in the reaction space 101 and configured to hold and rotate a substrate 10; a first heating part 421 disposed at a lower central region of the chamber 100 and configured to heat a central region of the reaction space 101; a second heating part 423 disposed at a lower peripheral region of the chamber 100 and configured to heat a peripheral region of the reaction space 101; and a blocking part 430 disposed between the first heating part 421 and the second heating part 423, including a top region extending to the above of the second heating part 423, and configured to block transfer of heat generated by the second heating part 423 to the central region of the reaction space 101.

A third heating part 300 may be further provided at an upper region of the chamber 100 to heat the reaction space 101. Although not shown in the drawings, a plasma generating apparatus may be provided in the reaction space 101 to generate plasma.

The chamber 100 includes a chamber body 110 defining the reaction space 101, an upper dome 120, and a lower dome 130.

The chamber body 110 is formed to have a cylindrical shape that is open at the top and bottom. In other words, it has a shape of a band rounded to be cylindrical. However, it is not limited thereto, and may be formed in a polyhedral barrel shape. A portion or all of the chamber body 110 may be formed of a metal material. In the present exemplary embodiment, the chamber body 110 is made using a material such as aluminum or stainless steel. The chamber body 110 may work as the sidewall of the reaction space 101 of the chamber 100. Although not illustrated, a substrate loading opening for loading/unloading substrates, and a terminal connecting portion of a gas supplying apparatus for supplying gases to the reaction space, may be formed on the chamber body 110.

The upper dome 120 is the top cover of the chamber body 110 (that is, an upper wall of the chamber 100). The lower region, i.e., the peripheral region of the upper dome 120 is attached to the top surface of the chamber body 110 and seals the top region of the reaction space 101. It may be effective to attach the upper dome 120 to the chamber body 110 so that it is attachable and detachable.

The upper dome 120 is made of a material with good thermal conductance in order to effectively transfer heat from the third heating part 300 to the reaction space 101. That is, the upper dome 120 may be manufactured of a transparent material (for example, quartz) that can effectively transfer radiant heat to the reaction space. Thus, radiant heat conducted from the reaction space of the chamber 100 to the upper dome 120 passes through the upper dome 120. The heat passing through the upper dome may be reflected back by the third heating part 300, so that it can pass through the upper dome 120 again and be conducted to the reaction space of the chamber 100. However, it is not limited thereto, and the upper dome 120 may be manufactured of a ceramic material.

The lower dome 130 is the bottom cover of the chamber body 110 (that is, the floor of the chamber 100). The lower dome 130 is attached to the bottom surface of the chamber body 110 to seal the lower region of the reaction space.

The lower dome 130 is made of a transparent material. The lower dome may be configured to effectively transfer radiant heat from the first heating part 421 and second heating part 423 located outside the chamber 100 to the reaction space inside the chamber 100. In the present exemplary embodiment, it may be effective to use quartz as the lower dome 130. Accordingly, the lower dome 130 may work as a window. Alternatively, a portion of the lower dome 130 may be made of a transparent material such that the other portion may be made of an opaque material with excellent thermal conductance.

As shown in FIG. 1, the lower dome 130 includes a floor plate 131 inclined downward, and an extending tube 132 protruding downward from the center of the floor plate 131. The floor plate 131 is formed to have an upside-down conical shape with its top and bottom portions open.

This way, the chamber 100 with the reaction space 101 is manufactured by coupling the chamber body 110, upper dome 120, and lower dome 130. The chamber 100 may have a pressure controller, a pressure sensor, and various devices for monitoring the inside of the chamber. A view port to view the reaction space through may be installed. An exhaust part may be further provided to exhaust impurities and unreacted material.

A substrate holding part 200 is provided in the reaction space 101 of the chamber 100 to hold a substrate 10 thereon.

The substrate holding part 200 includes a susceptor 210 on which a substrate is seated, a driveshaft 220 connected to the susceptor 210 and extending to the outside of the reaction space 101, and a driving apparatus 230 for elevating and/or rotating the driveshaft 220.

The susceptor 210 may be manufactured in a plate shape similar to the shape of the substrate 10. It may be preferable to manufacture the susceptor 210 with a material having a good thermal conductance. The susceptor 210 has one or more substrate holding region, such that one or more substrates 10 can be seated on the susceptor 210.

The driveshaft 220 extends to the outside of the chamber 100 through the extending tube 132, and the driving apparatus 230 may be any means which is capable of elevating and/or rotating the driveshaft 220. For example, in the present exemplary embodiment, a stage is used as the driving apparatus 230, and the stage may have a motor for elevation and/or rotation. Although not illustrated, the substrate holding part 200 may further include a plurality of lift pins for helping the substrate 10 be loaded and unloaded.

In the present exemplary embodiment, a first heating part 421 is disposed at a lower portion of the chamber 100 to heat the central region of the reaction space 101 of the chamber, and a second heating part 423 is provided for heating the peripheral region of the reaction space 101.

The first heating part 421 and the second heating part 423 are formed of at least one lamp heaters, respectively. The lamp heaters may employ a bulb-shaped or cylinder-shaped lamp heater. In the present exemplary embodiment, the first heating part 421 and the second heating part 423 respectively use a plurality of bulb-shaped lamp heaters. The lamp heaters are spaced apart from each other and disposed to make concentric arrangements having different diameters. The second heating part 423 may be disposed above the first heating part 421.

The first heating part 421 and the second heating part 423 are fixed to the lower portion of the chamber by means of a supporting portion 410. The supporting portion 410 may have a stepped configuration to locate the second heating part 423 above the first heating part 421. For example, the supporting portion 410 includes: a first lower support 411 supporting the lower portion of the first heating part 421; a second lower support 413 supporting the lower portion of the second heating part 423; a first inner support 415 and a first outer support 417 installed upward from the first lower support 411 and supporting the inner region and outer region, respectively, of the first heating part 421; and a second outer support 419 installed upward from the second lower support and covering the outer region of the second heating part 423.

For example, the first lower support 411 and second lower support 413 may have a shape of a horizontal annular band, the first inner support 415 and first outer support 417 may have a shape of an annular band vertical to the first lower support, and the second outer support 419 may have a shape of an annular band vertical to the second lower support 413.

In addition, the supporting portion 410 further includes partitioning plates 440 respectively partitioning a plurality of first heating parts 421 and second heating parts 423 on the first lower support 411 and second lower support 413. For example, 8 partitioning plates may be formed radially about the central region of the support 410. This way, heating regions (hereinafter referred to as “heating zones”) heated by the first heating parts 421 and the second heating part 423 are partitioned into 8 regions. The 8 heating zones are provided with the first heating parts 421 and the second heating parts 423. The power outputs of the first heating parts 421 and the second heating parts 423 in each heating zone may be set to be different from each other and controlled during processing in order to keep temperatures of the central region and peripheral region inside the reaction space 101 uniform. Even if the outputs of the first heating parts 421 and second heating parts 423 provided in the 8 heating zones are set differently from each other, temperatures across the substrate 10 can be kept uniform because the substrate 10 in the reaction space 101 of the chamber 100 is rotated by the substrate holding part 200 while a deposition process is performed.

The supporting portion 410 further includes a blocking part 430 between the first heating parts 421 and second heating parts 423. As the heat generated from the second heating parts 423 can be partially prevented from being transferred to the central region of the reaction space, temperatures at the central region and peripheral region of the reaction space 101 can be kept uniform during processing. Accordingly, temperatures at the central portion and peripheral portion of the substrate 10 can be kept uniform.

Top region or more regions of the blocking part 430 extends toward the above of the second heating parts 423, and partially block the transfer of heat generated by the second heating parts 423 to the central region of the reaction space 101. As shown in FIG. 1, an upper portion of the blocking part 430 is inclined toward the above of the second heating parts 423 with respect to a central axis S of the blocking part 430. This may be achieved by inclining, bending, curving the upper portion of the blocking part 430, or extending the upper portion using another member toward the above of the second heating parts 423.

For example, the blocking part 430 includes: a vertical blocking plate 431 installed vertically on top of the first outer support 417, i.e., between the first heating part 421 and second heating part 423; and an inclined blocking plate 433 formed on the top of the vertical blocking plate 431 and extended upward toward the above of the second heating part 423. The vertical blocking plate 431 and inclined blocking plate 433 may respectively be partitioned by the partitioning plate 440 into a plurality. For example, if a heating zone is partitioned into 8 zones by 8 partitioning plates as described above, 8 vertical blocking plates 431 and 8 inclined blocking plates 433 may be provided. As such, heat generated by the second heating parts 423 can be blocked by the vertical blocking plate 431 and inclined blocking plate 433, so that the transfer of heat to the central region of the reaction space 101 can be partially blocked.

By uniformly maintaining the temperatures at the central region and peripheral region of the reaction space 101, the temperatures at the central and peripheral portions of the susceptor 210 can be uniformly maintained, and consequently the temperatures at the central and peripheral portions of the substrate 10 can be uniformly maintained. As a result, a film deposition process can be performed under uniform condition.

The lengths and inclined angles of the plurality of vertical blocking plates 431 and inclined blocking plates 433 may be adjusted to keep temperatures at the central region and peripheral region inside the reaction space 101 uniform during processing.

Specifically, with reference to the modified examples in FIGS. 3 and 4, by changing the lengths of the inclined blocking plates 433a to 433d provided in each heating zone, it can be found that different amount of heat is blocked and transferred to the central region of the reaction space 101 depending on the lengths of the inclined blocking plates.

For example, by changing the lengths of the inclined blocking plates 433a to 433d provided at the heating zones corresponding to regions A to D, the blocking level of the heat which is generated by the second heating parts 423 and transferred to the central region of the reaction space 101 can be controlled. In this regard, when the temperature at the central region of the reaction space 101 is relatively higher than the temperature at the peripheral region during processing, the output of the second heating parts 423 provided at heating zones A and B with relatively low blocking levels is lowered, and the output of the second heating part 423 provided at heating zones C and D with relatively high blocking levels is raised to uniformly control the temperature within the reaction space 101.

A method for changing the lengths of the inclined blocking plates 433a to 433d may include, as shown in FIG. 3, sequentially increasing the lengths of the inclined blocking plates 433a to 433d provided at heating zones A to D, while making the lengths of the inclined blocking plates 433a to 433d in the opposite zones to be the same.

Also, as shown in the modified example of FIG. 5, the lengths of the inclined blocking plates 433 provided in the 8 heating zones may be made all different.

Methods for changing lengths of the inclined blocking plates 433 are not limited thereto, and various modifications may be implemented, such as changing the lengths of the inclined blocking plates 433 to be at any various number value.

Alternatively, the inclined angles of the inclined blocking plates 433 may be changed to control the blocking level of the heat which is generated from the second heating parts 423 and transferred to the central region of the reaction space 101, while the lengths of the inclined blocking plates 433 are maintained the same.

Also, as shown in FIG. 6, instead of changing the lengths or inclined angles of the inclined blocking plates 433, the lengths of the vertical blocking parts 431a to 431b provided at respective heating zones may be changed in order to control the blocking level of the heat generated by the second heating part 423.

For example, as shown in (A) to (D) of FIG. 6, by changing the lengths of the vertical blocking plates 431a to 431d provided at heating zones corresponding to A to D in FIG. 2, the blocking level of heat generated from the second heating parts 423 and transferred to the central region of the reaction space 101 may be controlled.

As in the exemplary embodiment and modified examples described above, instead of diversely modifying the lengths or inclined angles of and fixing the vertical blocking plates 431 and inclined blocking plates 433, the inclined angles and lengths of the inclined blocking plates 433 may be controlled to uniformly control the temperature at the central and peripheral regions inside the reaction space 101 during processing.

As in the exemplary embodiment of FIG. 7, by enabling adjustment of the inclined angle of the inclined blocking plate 433, the blocking level of heat generated from the second heating part 423 can be controlled and then the controlled heat is transferred to the central and peripheral regions of the reaction space 101.

For example, the inclined blocking plates 433 may be fixed at a hinge 435 provided respectively on the end of each vertical blocking plate 431. It may be preferable to provide the hinge 435 with pivotal force for pivoting the inclined blocking plate 433 by means of a separate driving apparatus.

As shown in the embodiments of FIGS. 8 and 9, by enabling adjustment of the extended length of the inclined blocking plate 433, the blocking level of heat generated from the second heating part 423 can be controlled and the controlled heat is transferred to the central region of the reaction space 101.

For example, the inclined blocking plate 433A in the exemplary embodiment of FIG. 8 is formed on the top end of the vertical blocking plate 431 and extends and inclines upwardly toward the above of the second heating part 423. The inclined blocking plate 433A includes a slider main body 433a having a slider groove 433a1 open at the end thereof, and a slider sub body 433b that slides along the slider groove 433a1 toward the above of the second heating part 423. Thus, the length of the inclined blocking plate 433A is changed as the slider sub body 433b is inserted into or pulled out from the slider body along the slider groove 433a1. Driving power needed to slide in and out of the slider sub body 433b can be provided by a separate driving apparatus.

Methods of changing the lengths of the inclined blocking plate 433 are not limited thereto. Referring to the exemplary embodiment of FIG. 9, the inclined blocking plate 433B may include: an extending main body 433c formed on the top end of the vertical blocking plate 431 and extending to be inclined toward the above of the second heating part 423; and an extending sub body 433d installed on the top surface and/or bottom surface of the extending main body 433c to slide out toward the above of the second heating part 423. According to the sliding of the extending sub body 433d along the top surface and/or bottom surface of the extending main body 433c, the length of the inclined blocking plate 433 can be changed. Driving power needed to slide in and out of the extending main body 433d can be provided by a separate driving apparatus.

Alternatively, the blocking part may be configured in a curved shape.

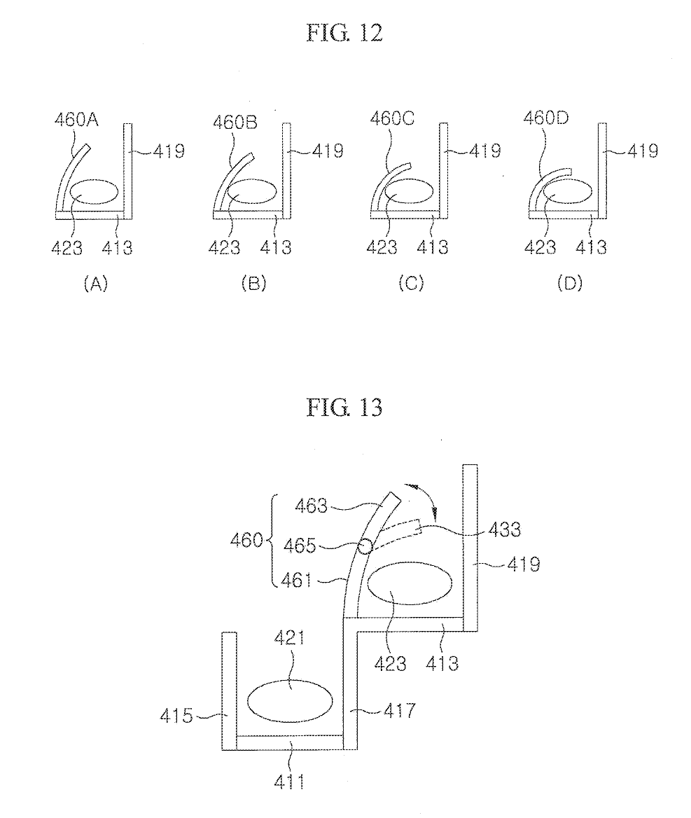

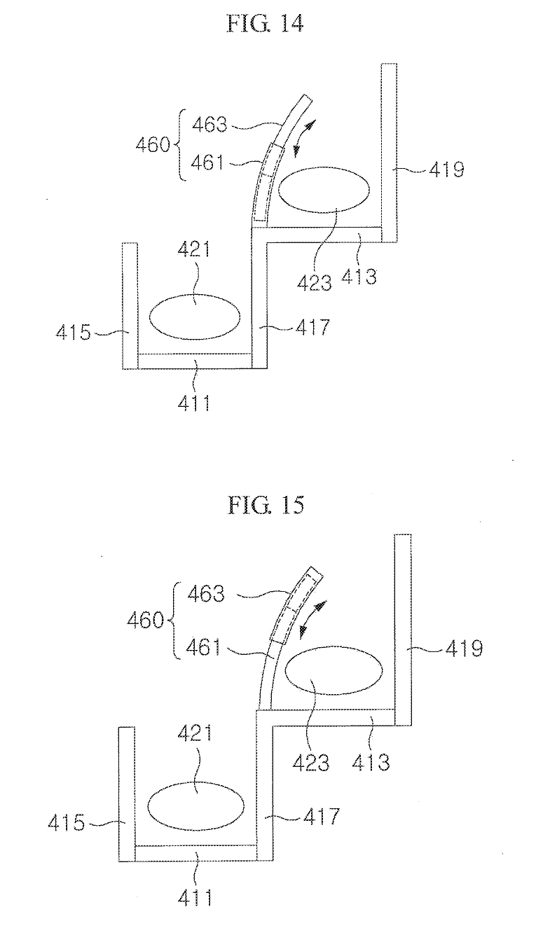

FIG. 10 is a schematic sectional view of a substrate processing equipment in accordance with another exemplary embodiment, and FIGS. 11 to 15 are vertical schematic sectional views of a heating part and a blocking part in accordance with modifications of another exemplary embodiment.

As shown in FIG. 10, the blocking part is installed, between the first heating part 421 and the second heating part 423, as a curved blocking plate 460 having its upper portion curved and extending toward the above of the second heating part 423. The curved blocking plate 460 may be divided into plurality by means of the partitioning plate. Thus, heat generated by the second heating part 423 is blocked by the curved blocking plate 460 and transfer of the heat to the central region of the reaction space 101 is partially restricted.

The length and radius of curvature of the curved blocking plate 460 can be variously changed as in the above-described vertical blocking plate 431 and inclined blocking plate 433, in order to uniformly control the temperatures of the central and peripheral regions inside the reaction space 101 during processing.

Specifically, as shown in the modified examples of FIG. 11, by variously changing the lengths of the curved blocking plates 460a to 460d provided in the heating zones A to D, blocking level of heat generated from the second heating parts 423 may be variously controlled and the controlled heat is transferred to the central region of the reaction space 101.

Alternatively, as shown in the modified examples of FIG. 12, by variously changing the radii of curvature for the curved blocking plates 460A to 460D while the overall lengths of the curved blocking plates 460A-460D are kept the same, the blocking level of heat generated from the second heating part 423 may be variously controlled and the controlled heat is transferred to the central region of the reaction space 101.

Referring to the modified examples of FIGS. 13 to 15, the inclined angles and lengths of the curved blocking plates 460 may be adjusted as in the vertical blocking plate 431 and inclined blocking plate 433 to uniformly control temperature at the central and peripheral regions inside the reaction space 101 during processing.

The curved blocking plate 460 is divided into a lower portion 461 installed between the first heating part 421 and the second heating part 423, and an upper portion 463 extending toward the above of the second heating part 423.

In the modified example of FIG. 13, the upper portion 463 is provided at the lower portion 461 such that it can be pivotable to adjust the inclined angle. This way, the blocking level of heat generated by the second heating part 423 can be controlled and the controlled heat is transferred to the central region of the reaction space 101.

For example, the curved blocking plate 460 includes a hinge 465 disposed between the lower portion 461 and upper portion 463 to apply pivoting force to the upper portion 463. Pivoting force needed to pivot the upper portion 463 of the curved blocking plate 460 can provided by a separate driving apparatus.

Referring to the modified examples of FIGS. 14 and 15, by enabling the adjustment of the extending length of the curved blocking plate 460, the blocking level of heat generated by the second heating part 423 may be controlled and the controlled heat is transferred to the central region of the reaction space 101.

Referring to the modified example of FIG. 14, the length of the curved blocking plate 460 can be changed as the upper portion 463 is slid into or out of the inside of the lower portion 461. Driving power needed to slide in and out the upper portion 463 may be provided by a separate driving apparatus.

Referring to the modified example of the curved blocking plate 460 in FIG. 15, the upper portion 463 may be configured to slide over the outside of the lower portion 461. That is, by sliding the upper portion 463 along the top surface and/or bottom surface of the lower portion 461 toward the above of the second heating part 423, the length of the curved blocking plate 460 is changed. Driving power needed to slide the upper portion 463 may be provided by a separate driving apparatus.

Exemplary embodiments of the present disclosure provide first heating parts and second heating parts spaced apart from each other and disposed to make concentric arrangements with different diameters, as a heating part of a lower portion of the chamber. However, the number of heating parts is not limited thereto, and may be modified in various ways. It may be preferable that a blocking part is provided between each heating part.

In accordance with the exemplary embodiments of the present disclosure, heat transfer from the lower peripheral region of the chamber to the central region within the chamber can be controlled, so that temperature of inside of the chamber, particularly the susceptor, can be kept uniform.

In specific, a blocking part is provided between a heating part disposed at a lower central region of the chamber and a heating part disposed at a lower peripheral region of the chamber, and the lengths and inclined angles of the blocking part can be changed. As a result, uneven distribution of temperature inside of the chamber can be adjusted promptly.

Although the substrate processing equipment has been described with reference to the specific embodiments, it is not limited thereto and may be embodied in various different forms. The above embodiments are provided to thoroughly disclose the present disclosure and its subject matter to those having ordinary skill in the art, and the spirit and scope of the present disclosure are defined by the appended claims.

What is claimed is:

1. A substrate processing equipment comprising:
a chamber comprising a reaction space;
a substrate holding part in the reaction space and adapted to hold and rotate a substrate;
a first heating part below a central region of the chamber and adapted to heat a central region of the reaction space;
at least one second heating part below a peripheral region of the chamber and adapted to heat a peripheral region of the reaction space; and
a blocking part between the first heating part and the second heating part, the blocking part having a top portion above the second heating part, and configured to block transfer of heat from the second heating part to the central region of the reaction space.

2. The substrate processing equipment of claim 1, wherein the blocking part comprises:
a vertical blocking plate between the first heating part and the second heating part; and
an inclined blocking plate at an uppermost end of the vertical blocking plate, extending and inclined upwardly above the second heating part.

3. The substrate processing equipment of claim 1, wherein the blocking part comprises a curved blocking plate between the first heating part and the second heating part, with an upper portion thereof extending above the second heating part.

4. The substrate processing equipment of claim 1, wherein the second heating part is provided in plurality and spaced apart from each other,
the substrate processing equipment further comprises a supporting portion below the chamber, the supporting portion supporting the first heating part and the second heating part, and
the supporting portion comprises a plurality of partitioning plates for partitioning at least the second heating parts.

5. The substrate processing equipment of claim 4, wherein the blocking part comprises:
a plurality of vertical blocking plates between the first heating part and the second heating parts, separated by the plurality of partitioning plates; and
an inclined blocking plate at an uppermost end of the respective vertical blocking plates, extending and inclined upwardly above the second heating part.

6. The substrate processing equipment of claim 5, wherein at least one of the plurality of vertical blocking plates has a different height from another of the plurality of vertical blocking plates.

7. The substrate processing equipment of claim 5, wherein at least one inclined blocking plate extends at a different angle with respect to the vertical blocking plate from another inclined blocking plate.

8. The substrate processing equipment of claim 5, wherein at least one inclined blocking plate has a different length from another inclined blocking plate.

9. The substrate processing equipment of claim 5, wherein the inclined blocking plate is pivotable at the uppermost end of the vertical blocking plate.

10. The substrate processing equipment of claim 9, wherein the inclined blocking plate is fixed to a hinge at the uppermost end of the vertical blocking plate.

11. The substrate processing equipment of claim 5, wherein the inclined blocking plate has a variable length.

12. The substrate processing equipment of claim 11, wherein each inclined blocking plate comprises:
a slider main body at the uppermost end of the respective vertical blocking plate, extending and inclined upwardly above the second heating part, and comprising a slider groove or opening at an end thereof; and
a slider sub body configured to extend from and retract into the slider groove or opening, above the second heating part.

13. The substrate processing equipment of claim 11, wherein each inclined blocking plate comprises:
a main body at the uppermost end of the vertical blocking plate, extending and inclined upwardly above the second heating part; and
an extending sub body comprising a groove or opening at an end thereof, the extending sub body configured to slide along at least one surface of the main body, above the second heating part.

14. The substrate processing equipment of claim 4, wherein the blocking part comprises a plurality of curved blocking plates between the first heating part and the second heating part, the curved blocking plates being separated by the plurality of partitioning plates, and an upper portion of the curved blocking plates extends above of second heating part.

15. The substrate processing equipment of claim 14, wherein at least one of the plurality of curved blocking plates has a different length from another of the plurality of the curved blocking plates.

16. The substrate processing equipment of claim 14, wherein at least one of the plurality of curved blocking plates has a different radius of curvature than another of the plurality of the curved blocking plates.

17. The substrate processing equipment of claim 14, wherein each of the plurality of curved blocking plates has a lower portion between the first heating part and the second heating part, and an upper portion extending above the second heating part, and
the upper portion is pivotable with respect to the lower portion and has a variable inclined angle.

18. The substrate processing equipment of claim 17, wherein each of the plurality of curved blocking plates comprises a hinge between the lower portion and the upper portion.

19. The substrate processing equipment of claim 14, wherein each of the plurality of curved blocking plates has a lower portion between the first heating part and the second heating part, and an upper portion extending above the second heating part, and
the upper portion extends away from the lower portion, or retracts towards the lower portion, to enable each curved blocking plate to have a variable length.

20. The substrate processing equipment of claim 1, further comprising
a supporting portion below the chamber, supporting the first heating part and the second heating part, wherein the supporting portion has a stepped configuration such that the second heating part is above the first heating part.

21. A method of making substrate processing equipment, comprising:
assembling
a chamber comprising a reaction space,
a substrate holding part in the reaction space and adapted to hold and rotate a substrate,
a first heating part below a central region of the chamber and adapted to heat a central region of the reaction space, and
a second heating part below a peripheral region of the chamber and adapted to heat a peripheral region of the reaction space; and
attaching a blocking part between the first heating part and the second heating part, the blocking part having a top portion above the second heating part, and configured to block transfer of heat from the second heating part to the central region of the reaction space.

22. A method of affecting heat transfer in substrate processing equipment, comprising:
attaching a blocking part between first and second heating parts in the substrate processing equipment, the substrate processing equipment comprising
a chamber comprising a reaction space,
a substrate holding part in the reaction space and adapted to hold and rotate a substrate,
the first heating part, below a central region of the chamber and adapted to heat a central region of the reaction space, and
the second heating part, below a peripheral region of the chamber and adapted to heat a peripheral region of the reaction space,
the blocking part having a top portion above the second heating part, configured to block transfer of heat from the second heating part to the central region of the reaction space; and
optionally, extending an upper portion of the blocking part above of the second heating part or retracting the upper portion of the blocking part top portion towards a lower portion of the blocking part top portion, to change a transfer of heat from the second heating part to the central region of the reaction space.
